(19) United States
(12) Patent Application Publication
(10) Pub. No.: US 2010/0139227 A1
(43) Pub. Date: Jun. 10, 2010

(54) Disengageable Drive Arrangement for a Lawn Mower and a Lawn Mower with Such a Drive

(76) Inventor: Jörgen Johansson, Jonkoping (SE)

Correspondence Address: MOORE & VAN ALLEN PLLC, P.O. BOX 13706, Research Triangle Park, NC, 27709, US

(21) Appl. No.: 12/593,331

(22) PCT Filed: Mar. 29, 2007
(86) PCT No.: PCT/SE07/00298

§ 371 Date: Jan. 5, 2010

(51) Int. Cl. A01D 69/08; A01D 34/00

(52) U.S. Cl. 56/11.3; 56/13.7

(57) ABSTRACT

A disengageable drive arrangement (1) for a lawn mower is provided, said arrangement comprising a gear box assembly (2), said gear box assembly (2) being mountable for rotation about a first axis (A1) under the action of a rotational force (F1) acting at a point of application on the gear box assembly (2), wherein a rotational position of said gear box assembly (2) about said first axis (A1) is controllable by a cable force (F2) applied by a cable (7), and wherein the cable is connected to the gear box assembly (2) via a force transmission arrangement (20) such that the rotational force (F1) applied on the gear box assembly (2) at said point of application is greater than the cable force (F2) applied by the cable (7).

### TECHNICAL FIELD

The present document relates to a drive arrangement for a walk behind lawnmower. In particular, the present document relates to a drive arrangement as defined by the appended independent claim.

### BACKGROUND

Conventional walk behind lawn mowers comprise a chassis, an engine, a cutting blade, wheels and a handle.

The rotating cutting blade is generally arranged at the middle of the chassis, and is, for grass collection and security reasons, covered by a a cutting deck.

The engine may be arranged at the cutting deck, above the cutting blade, so as to transmit the fast rotation of the engine shaft directly to the cutting blade.

The engine power is also used for driving the lawn mower drive wheels at the front or back of the chassis. For this purpose, a lawn mower powertrain may be provided, comprising a belt transmission and a gear box arranged between the engine output shaft and an axle driving the drive wheels.

The belt transmission may comprise an engine pulley connected to the engine shaft and an input pulley connected to a gearbox input shaft.

The purpose of the gear box is to reduce and redirect the fast rotation of the vertical engine shaft into a suitable rotational speed of the horizontal axis driving the wheels.

U.S. Pat. No. 4,907,401 discloses a gear box casing, which is rotatably mounted about the wheel axle for providing a main clutch which is engaged and disengaged by a selective tightening and loosening of an input belt for the casing by rotational displacement of the casing.

It is also known from recent lawn mower types to provide a disengageable and/or speed regulating drive function of a lawnmower with a clutch-less powertrain, by controlling a degree of slipping of the belt transmission. This may be done by rotating the gear arrangement, and thus the input pulley, about an axle connected to the drive wheels. Such arrangements can be manufactured at low cost. They can also be made relatively simple and space-efficient.

The rotation of the gear arrangement is usually carried out by the user manoeuvring a wire extending from the handle bar of the lawn mower.

However, such drive arrangements require a manoeuvring force which, for some users, may be difficult, or uncomfortable, to provide.

It may further be difficult for the user to adjust the speed of such drive arrangements.

### SUMMARY

In view of the above, it is an objective of the present disclosure to provide an alternative and/or improved drive arrangement. In particular, an objective is to provide a drive arrangement which requires less manoeuvring force to be applied by the user. It is an additional object to decrease the load on the wire. It is also an additional object to provide a compact solution that takes up little space when mounted on a lawn mower.

According to a first aspect of the present solution, there is provided a disengageable drive arrangement for a lawn mower, said arrangement comprising a gear box assembly having at least one input shaft, a housing, and at least one output shaft, wherein said output shaft is drivingly connectable to a propulsion member, such as a drive wheel, disposed to be in contact with the ground during operation of the lawn mower, said gear box assembly being mountable for rotation about a first axis under the action of a rotational force acting at a point of application on the gear box assembly, wherein a rotational position of said gear box assembly about said first axis is controllable by a cable force applied by a cable, and wherein the cable is connected to the gear box assembly via a force transmission arrangement such that the rotational force applied on the gear box assembly at said point of application is greater than the cable force applied by the cable.

By “point of application” is understood the established meaning of the expression, that is the centre of the force application as used by those skilled in the art when performing force calculations. However, the physical connection between the force transmission arrangement and the gear box assembly is not necessarily limited to a point.

By “cable” is understood any suitable wire, cable or rod known in the art. The cable may be of the same material and/or stiffness along its entire length, or be of variable stiffness and/or comprise several materials.

The solution results in a reduction of the requisite manoeuvring force, and thus of a more comfortable manoeuvring of the lawn mower.

It also reduces the force exerted on the cable, and thus the demands on the cable construction.

Moreover, the drive arrangement is well suited for providing a variable speed function, since the force transmission arrangement results in a longer cable stroke that makes it easier for the user to adjust the speed by manoeuvring the cable.

The drive arrangement may further comprise return spring means for biasing the rotational position of said gear box assembly.

The drive arrangement may further comprise cable overload protection spring means.

The cable overload protection spring means may be arranged between the cable and its connection to said gear box assembly.

The purpose of the cable overload protection spring means is to unload the cable, thus reducing strain and risk of damage on the cable.

The return spring means and the cable overload protection spring means may be any suitable spring means known in the art, such as for example a coil spring.

The transmission arrangement may comprise a lever. Levers are well-tested and low-complexity components well known in the art.

The lever may comprise a cable connecting portion, wherein the cable is connected, and an abutment portion.

The lever may be rotatably connected to the gearbox assembly about a second axis, which is positioned between said connecting portion and said abutment portion.

A point of action of the cable at the lever may be at a distance from the axis.

The second axis may be pivotable about the first axis in response to the cable force.

The second axis may be a geometrical axis. By “pivotable about” is understood how the axis is movable relative to the first axis, and it does not imply that the second axis has a point of connection to the first axis.

The abutment portion may be adapted for sliding engagement with a support.

The abutment portion may be adapted for rotating engagement with a support.

The rotating force may be applied to the gear box assembly at the second axis.

The abutment portion provides a compact solution, since it results in a relatively short lever being capable of transmitting a desired rotational force to the gear box assembly.

The transmission arrangement may comprise a guide element arranged for deflecting the cable.

The deflection results in a force transmission that produces a rotational force with greater magnitude than the applied cable force, without the need of separate supports.

Thus, a guide element may be mounted entirely on the gear box assembly. This allows displacement of the gear box assembly, which may be useful for adjustment of a powertrain belt transmission connected to the gear box assembly.

The cable may be displaceable about the guide element in response to the cable force.

The rotating force may be applied to the gear box assembly at its connection to the guide element.

The guide element may be adapted for mainly sliding engagement with the cable.

The guide element may be substantially fixed relative to the gear box assembly.

The guide element may be rotatable about a second axis.

The guide element may comprise sheave.

According to a second aspect of the present solution a lawn mower is provided, comprising a drive arrangement according to the present solution.

The drive arrangement may further comprise an input belt pulley for engagement with a transmission belt.

A relative motion between the transmission belt and the input belt pulley may be controllable by the rotational position of the gear box assembly.

The relative motion between the transmission belt and the input belt pulley may be arranged to provide a speed regulating function for the lawn mower.

The rotational position of the gear box assembly, and the associated relative motion between the transmission belt and the input belt pulley may provide the only clutch function of the drive arrangement, and/or of the gear box assembly.

The cable may be connected to a control device of said lawn mower.

It may be a one-hand or a two-hand control device. The control device may be a handle. The complexity of the control device arrangement may depend on the intended use. If, for example, the lawn mower is intended for single speed drive, the control device may be a low-complexity handle with two-handed grip. If the intended use is variable speed drive, a handle with a one-handed grip may be more suitable.

The lawn mower may further comprise a support for the abutment portion.

The abutment portion may be displaceable along the support in a longitudinal direction of the lawn mower.

This allows adjustment of the powertrain by displacement of the gear box assembly, and thus of the output shaft of the gear box assembly, in a horizontal direction substantially perpendicular to the length direction of the output shaft of the gear box assembly.

### BRIEF DESCRIPTION OF THE DRAWINGS

Other objectives, features and advantages of the present solution will be better understood through the following illustrative and non-limiting detailed description of embodiments of the present solution, with reference to the appended drawings, where the same reference numerals will be used for similar elements, wherein:

FIG. 1 shows a schematic side view of part of a lawn mower powertrain when no cable force is applied by the user.

FIG. 2 shows, in a schematic and more detailed view from the opposite side, the force transmission of the powertrain in FIG. 1.

FIG. 3 shows the schematic view of FIG. 1 when a cable force is applied by the user.

FIG. 4 shows the view in FIG. 2 when a cable force is applied.

FIG. 5 shows, in a partially cut-out perspective view, the embodiment in FIGS. 1-4.

FIG. 6 shows, in a schematic perspective view, a second embodiment of the drive arrangement force transmission.

### DETAILED DESCRIPTION OF EMBODIMENTS

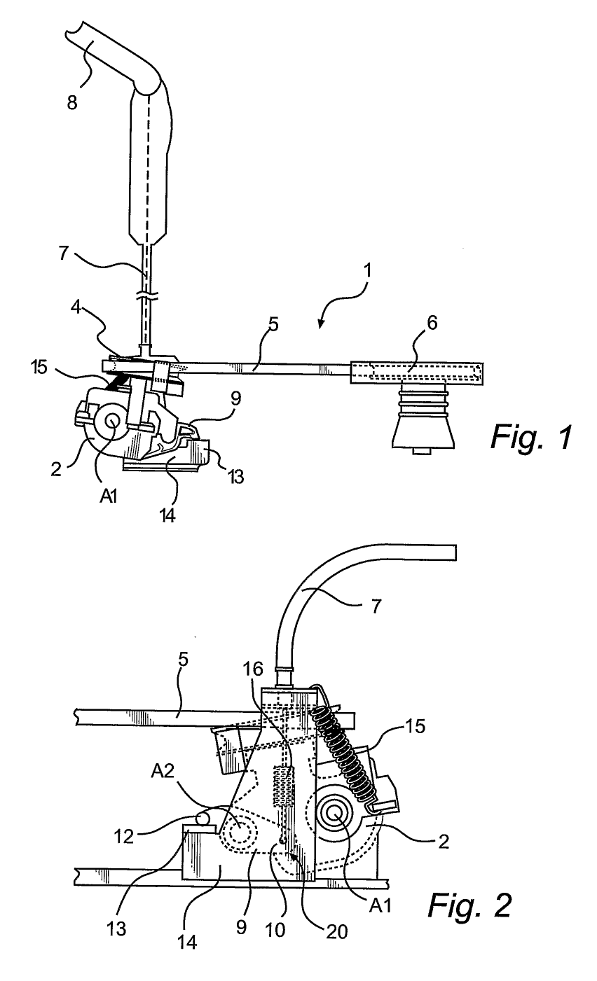

FIG. 1 shows a part of a lawn mower powertrain comprising a drive arrangement 1. A gear box assembly 2 with an input shaft and an output shaft is rotatably mounted about a horizontal axis A1. An input belt pulley 4 is arranged on the gear box input shaft, which input belt pulley 4 via a belt 5 is connected to an engine belt pulley 6 arranged on an engine shaft. The rotational position of the gearbox assembly 2 is controllable by manoeuvring of a cable 7 which is connected to the handle 8. The cable 7 is connected to the gearbox assembly 2 via a force transmission arrangement 20 illustrated in FIG. 2, which is a schematic view from the opposite side.

Referring to FIG. 2, the force transmission arrangement 20 comprises a lever 9, to which the cable 7 is connected at a cable connection portion 10. The lever 9 may be pivotally connected to the gear box assembly 2 about an axis A2. An abutment portion 12 of the lever 10 may be arranged for sliding and rotating engagement with a support 13 provided at a separate part 14. Return spring 15, which may be in the form of a coil spring, may be arranged for biasing the rotational position of the gear box assembly 2. Between the cable 7 and its connection to the lever 9, a cable overload protection spring 16 in the form of a coil spring may be arranged to unload the cable 7.

FIGS. 1 and 2 show the embodiment when no cable force F2 is applied by the user. The rotational position of the gear box assembly 2 may be biased by the return spring 15, resulting in the gearbox assembly 2, and thus the input belt pulley 4, being angled relative to a drive position. This causes the belt 5 to slip, and thus the drive is disengaged.

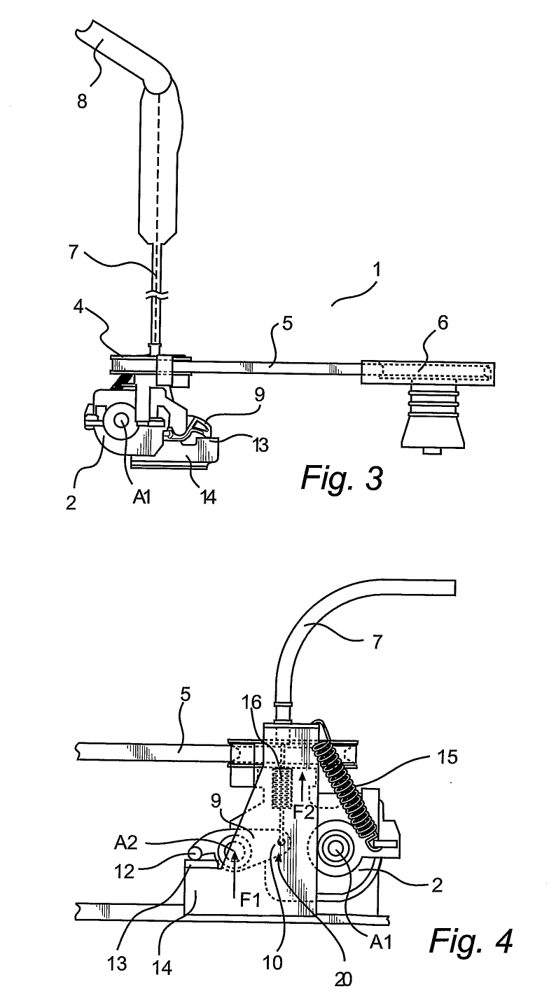

FIGS. 3 and 4 correspond to the respective FIGS. 1 and 2, but depicts the powertrain and drive arrangement 1 when a sufficient cable force F2 is applied to achieve the drive position.

Referring to FIG. 3, the cable force F2, which may be applied by the user by pulling the handle 8 upwards, results in a rotational displacement of the gear box assembly 2 and, thus, of the input belt pulley 4. This tightens the belt 5, and the drive is engaged accordingly.

In FIG. 4 it can be seen how the manoeuvring force applied by the user, which creates the cable force F2 in the cable 7, due to the force transmission arrangement 20, may result in a rotating force F1 which is greater than the cable force F2. When the cable force F2 pulls the cable connecting portion 10 of the lever 9 upwards, the abutment portion 12 slidingly and rotatingly engages the support 13. This results in the rotating force F1 applied at the point of application, that is at the centre of the lever's pivotal connection to the gear box assembly 2, about the axis A2, being, as a non-limiting example, substantially twice the size of the cable force F2. Thus, the requisite manoeuvring force is reduced, as is the risk of discomfort being experienced by the user. Moreover, the force transmission arrangement reduces the strain on the cable

It should be noted that the exact rotating force may be chosen according to what is found to be suitable.

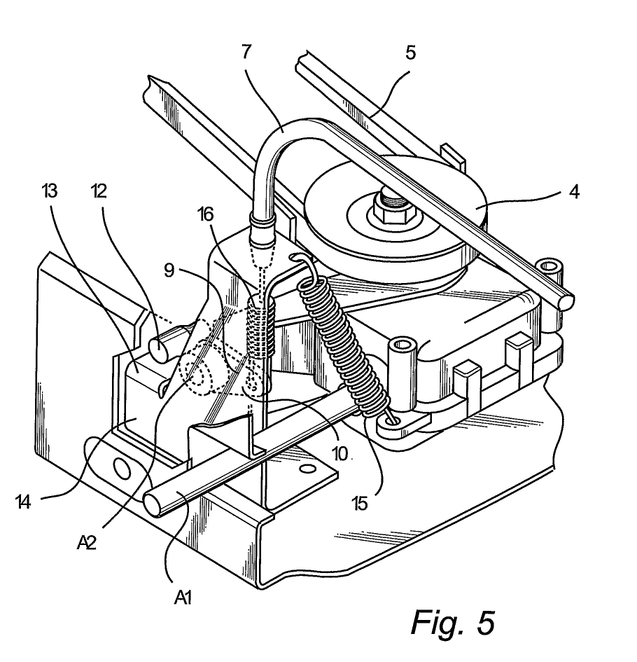

FIG. 5 shows the embodiment described above in a partially cut-out perspective view. It can be seen how the abutment portion 12 rests on the support 13 of the separate part 14.

The support may form part of the lawn mower chassis.

In an alternative embodiment, the cable 7 may be at least partially stiff.

In another embodiment, the support 13 may be in the form of a link arrangement connected to the lever 9 so as to provide a support while allowing the necessary displacement of the lever.

The lever 9 may be resilient and/or flexible, in which case it may, but does not need to, be rotatably connected to the gear box assembly 2.

The cable connecting portion 10 may or may not be at an end of said lever 9.

The lever's connection to the gear box assembly 2 may be arranged at any suitable distance from said cable connecting portion 10 and said abutment portion 12, according to the desired transmission ratio.

The abutment portion 12 may be curved.

The spring means 15, 16 may be any suitable spring means known in the art.

The support 13 may be sufficiently long to allow displacement of the gear box assembly 2 in a direction perpendicular to the length direction of the axis A1, which allows adjustment of the powertrain by displacement of the axis A1 driven by the gear box assembly 2.

The axis A1 may or may not be directly connectable to the drive wheels, and may or may not be a wheel axle.

The support may form an integrated part of the chassis, or be provided on a separate part.

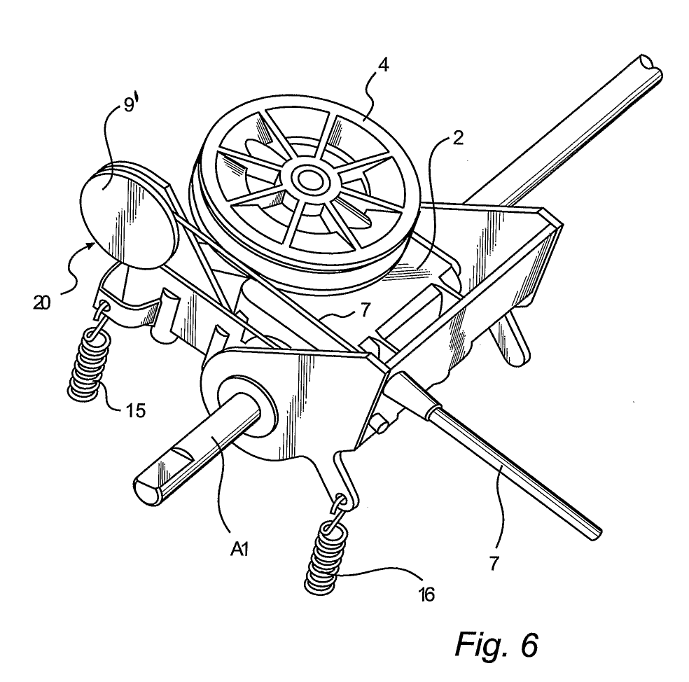

FIG. 6 shows, in a schematic perspective view, a second embodiment. A guide element 9′ in the form of a sheave is arranged on the gear box assembly 2 to deflect the cable 7, thus providing a force transmission arrangement 20 which results in the rotational force F1 applied to the gear box assembly, being substantially twice the cable force F2 applied in the cable 7.

The guide element 9′ may be formed in one piece with said gear box assembly 2.

The guide element may or may not be pivotaly connected to the gear box assembly.

The solution has mainly been described above with reference to a few embodiments. However, as is readily appreciated by a person skilled in the art, other embodiments than the ones disclosed above are equally possible within the scope of the invention, as defined by the appended patent claims.

1. A disengageable drive arrangement for a lawn mower, the drive arrangement comprising:
a gear box assembly comprising at least one input shaft, a housing, and at least one output shaft, wherein the at least one output shaft is drivingly connectable to a propulsion member disposed to be in contact with the ground during operation of the lawn mower, and
wherein the gear box assembly is mountable for rotation about a first axis under the action of a rotational force acting at a point of application on the gear box assembly, and a rotational position of the gear box assembly about the first axis is controllable by a cable force applied by a cable, wherein the cable is connected to the gear box assembly via a force transmission arrangement such that the rotational force applied on the gear box assembly at the point of application is greater than the cable force applied by the cable.

2. The drive arrangement as claimed in claim 1, further comprising return spring means for biasing the rotational position of the gear box assembly.

3. The drive arrangement as claimed in claim 1, further comprising cable overload protection spring means for unloading the cable.

4. The drive arrangement as claimed in claim 1, wherein the force transmission arrangement comprises a lever.

5. The drive arrangement as claimed in claim 4, wherein the lever comprises a cable connecting portion to which the cable is connected, and an abutment portion.

6. The drive arrangement as claimed in claim 5, wherein the lever is rotatably connected to the gearbox assembly about a second axis positioned between the cable connecting portion and the abutment portion.

7. The drive arrangement as claimed in claim 6, wherein a point of action of the cable at the lever is at a distance from the second axis.

8. The drive arrangement as claimed in claim 6, wherein the second axis is pivotable about the first axis in response to the cable force.

9. The drive arrangement as claimed in claim 5, wherein the abutment portion is adapted for sliding engagement with a support.

10. The drive arrangement as claimed in claim 5, wherein the abutment portion is adapted for rotating engagement with a support.

11. The drive arrangement as claimed in claim 6, wherein the rotational force is applied to the gear box assembly at the second axis.

12. The drive arrangement as claimed in claim 1, wherein the force transmission arrangement comprises a guide element arranged for deflecting the cable.

13. The drive arrangement as claimed in claim 12, wherein the cable is displaceable about the guide element in response to the cable force.

14. The drive arrangement as claimed in claim 12, wherein the rotational force is applied to the gear box assembly at its connection to the guide element.

15. The drive arrangement as claimed in claim 12, wherein the guide element is adapted for mainly sliding engagement with the cable.

16. The drive arrangement as claimed in claim 12, wherein the guide element is substantially fixed relative to the gear box assembly.

17. The drive arrangement as claimed in claim 12, wherein the guide element is rotatable about a second geometric axis.

18. The drive arrangement as claimed in claim 17, wherein the guide element comprises a sheave.

19. A lawn mower comprising the drive arrangement as claimed in claim 1.

20. The lawn mower as claimed in claim 19, wherein the drive arrangement further comprises an input belt pulley for engagement with a transmission belt.

21. The lawn mower as claimed in claim 20, wherein a relative motion between the transmission belt and the input belt pulley is controllable by the rotational position of the gear box assembly.

22. The lawn mower as claimed in claim 20, wherein the relative motion between the transmission belt and the input belt pulley is arranged to provide a speed regulating function for the lawn mower.

23. The lawn mower as claimed in claim 20, wherein the rotational position of the gear box assembly, and an associated relative motion between the transmission belt and the input belt pulley provides a clutch function of a lawn mower powertrain.

24. The lawn mower as claimed in claim 19, wherein the cable is connected to a control device of the lawn mower.

25. A lawn mower, comprising the drive arrangement as claimed in claim 5, and further comprising a support for the abutment portion.

26. The lawn mower as claimed in claim 25, wherein the abutment portion is displaceable along the support in a longitudinal direction of the lawn mower.
